(19) United States
(12) Patent Application Publication
(10) Pub. No.: US 2006/0231990 A1
(43) Pub. Date: Oct. 19, 2006

(54) Gas spring

(75) Inventors: Frank Born, Dienethal (DE); Gerard Kerschen, Mamer (LU); Jan Leyendecker, Schmelz (DE); Markus Mayer, Trier (DE); Rainer Massmann, Bonn (DE); Rolf Mintgen, Thuer (DE); Stephan Scherer, Freiburg (DE)

Correspondence Address: COHEN, PONTANI, LIEBERMAN & PAVANE, 551 FIFTH AVENUE, SUITE 1210, NEW YORK, NY, 10176, US

(73) Assignee: Stabilus GmbH, Koblenz (DE)

(21) Appl. No.: 11/387,244

(22) Filed: Mar. 23, 2006

(30) Foreign Application Priority Data
Mar. 23, 2005 (DE) 102005013413.0-12

(51) Int. Cl. F16F 5/00

(52) U.S. Cl. 267/64.14

(57) ABSTRACT

A gas spring has a closed cylinder, the interior of which is divided into a first working space and a second working space by a piston, which is free to slide back and forth in the cylinder. The piston has a piston rod, which extends through the second working space and out from the cylinder through a seal. The first working space and the second working space are filled with pressurized gas. A compensating space, which is filled with a compensating medium, is also provided. The volume of this compensating medium changes with the temperature, and this change in volume brings about a corresponding change in the volume of the first working space. The compensating medium is an incompressible medium which expands in volume as the temperature drops, this expansion leading to a decrease in the volume of the first working space.

### BACKGROUND OF THE INVENTION

1. Field of the Invention

The invention relates to a gas spring that has a closed cylinder, the interior of which is divided into a first working space and a second working space by a piston, which is free to slide back and forth in the cylinder; a piston rod on the piston, the rod extending through the second working space and out from the cylinder through a seal, where the first working space and the second working space are filled with pressurized gas; and a compensating space, which is filled with a compensating medium, the volume of which changes with the temperature, where this change in volume brings about a corresponding change in the volume of the first working space.

2. Description of the Related Art

In gas springs of this type, it is known that a compensating medium can be used which expands in volume when the temperature rises and as a result decreases the volume of the first working space.

When a gas spring of this type is used in a motor vehicle, functionality must be guaranteed not only at temperatures of up to +80° C. but also at temperatures as low as −30° C.

Because the volume of the compensating medium decreases when the temperature drops, the volume of the first working space increases again. A drop in temperature thus also leads to a decrease in the outward-directed force which the gas spring can produce. Especially at very low temperatures, this can lead to the inability of the gas spring to exert sufficient force on the component to be moved, e.g., a hatch. At high temperatures, furthermore, the outward-directed force can increase to such an extent that it can be very difficult to push the components of the gas spring back into each other again.

### SUMMARY OF THE INVENTION

An object of the invention is therefore to create a gas spring of the type indicated above which guarantees adequate outward thrust even at low environmental temperatures and which also prevents the outward-directed force from increasing when the temperature increases.

This object is accomplished according to the invention in that the compensating medium is an incompressible medium which expands in volume when the temperature decreases, this expansion causing the volume of the first working space to decrease.

As a result of this design, sufficiently high outward-directed thrust is guaranteed even at low temperatures, and at high temperatures the force required to push the gas spring back together does not increase.

The volume of the compensating medium preferably increases continuously as the temperature continuously drops.

To optimize this behavior, the increase in the volume of the compensating medium during a phase of falling temperature is sufficient to compensate for the drop in pressure in the first working space caused by the drop in temperature.

A low-cost compensating medium is water or an aqueous medium.

If the compensating medium is an aqueous emulsion, the individual drops of water can, for example, be held in suspension in the carrier liquid by an emulsifier or surfactant. When the water freezes and the volume of the emulsion as a whole expands, the carrier fluid ensures an easy reversal of direction of the ice and prevents plugs from forming, because the small, individual volumes of ice remain separate and are thus able to slide past each other.

The first working space is preferably separated from the compensating medium by a movable wall.

For this purpose, the movable wall can be a membrane or a separating piston installed in the cylinder with freedom to slide back and forth so that it separates the first working space from the compensating space holding the compensating medium.

Alternatively or in addition, the compensating medium can be provided inside a flexible sleeve, which can be an elastic sleeve.

By installing the flexible sleeve in the first working space, the compensating space can be located in the first working space, thus reducing the size of the unit and simplifying its design.

A compact design of reduced length can be achieved by surrounding the cylinder with a compensating cylinder, which is a certain distance away from the cylinder and is closed at both ends. The annular space formed between the cylinder and the compensating cylinder is the compensating space. The flexible sleeve can be installed in this annular space.

So that the compensating medium can be easily rerouted as it freezes, the movable wall can be a plastically deformable, incompressible transfer medium.

For this purpose, the incompressible transfer medium can be a sponge. Thus, the direction of the ice is easily reversed by embedding the ice in the sponge. Through the choice of suitable material, the sponge itself is incompressible and transmits the deformation in the form of a relative movement so that the volume of the first working space is changed as required.

Additional possibilities of redirecting the compensating medium include providing an elastomeric component as the incompressible transfer medium or by providing a fluid-filled flexible sleeve as the incompressible transfer medium, the volume of this fluid remaining at least more-or-less constant during changes in temperature.

An especially large decrease in the volume of the first working space under the effect of falling temperatures can be achieved by using a piston component, installed with freedom to slide in a cylinder component, to divide the interior space of this closed cylinder component into a first chamber connected to the first working space and a second chamber, where one end of an axially oriented displacement pin is permanently installed in the first or second chamber, whereas the other end projects through a seal into a compensating chamber provided in the piston component, this chamber being filled with additional compensating medium. If the displacement pin is permanently installed in the first chamber, falling temperatures cause the additional compensating medium to expand, or, if the displacement pin is permanently installed in the second chamber, falling temperatures cause the compensating medium to expand.

Other objects and features of the present invention will become apparent from the following detailed description considered in conjunction with the accompanying drawings. It is to, be understood, however, that the drawings are designed solely for purposes of illustration and not as a definition of the limits of the invention, for which reference should be made to the appended claims. It should be further understood that the drawings are hot necessarily drawn to scale and that, unless otherwise indicated, they are merely intended to conceptually illustrate the structures and procedures described herein.

### BRIEF DESCRIPTION OF THE DRAWINGS

Exemplary embodiments of the invention are illustrated in the drawings and described in greater detail below:

FIG. 1 is a cross-sectional view of first exemplary embodiment of a gas spring;

FIG. 2 is a cross-sectional view of a second exemplary embodiment of a gas spring;

FIG. 3 is a cross-sectional view of a third exemplary embodiment of a gas spring;

FIG. 4 is a cross-sectional view of a fourth exemplary embodiment of a gas spring;

FIG. 4A is a cross-section view of a variation of the fourth exemplary embodiment shown in FIG. 4;

FIG. 5 is a cross-sectional view of a fifth exemplary embodiment of a gas spring;

FIG. 6 is a cross-sectional view of a sixth exemplary embodiment of a gas spring;

FIG. 7 is a cross-sectional view of a seventh exemplary embodiment of a gas spring;

FIG. 8 is a cross-sectional view of an eighth exemplary embodiment of a gas spring; and

FIG. 9 is a cross-sectional view of a ninth exemplary embodiment of a gas spring.

### DETAILED DESCRIPTION OF THE PRESENTLY PREFERRED EMBODIMENTS

Each of the gas springs shown in the figures has a closed cylinder 1, in which a piston 2 is installed with the freedom to slide back and forth. The piston 2 divides the interior of the cylinder 2 into a first working space 3 and a second working space 4.

A piston rod 5 is attached to one side of the piston 5. This rod extends through the second working space 4 and out from the cylinder through a seal.

The first working space 3 and the second working space 4 are filled with pressurized gas.

A compensating space 6 is also present, in which an incompressible compensating medium is provided, which expands in volume when the temperature drops. This expansion leads to a corresponding decrease in the volume of the first working space 3.

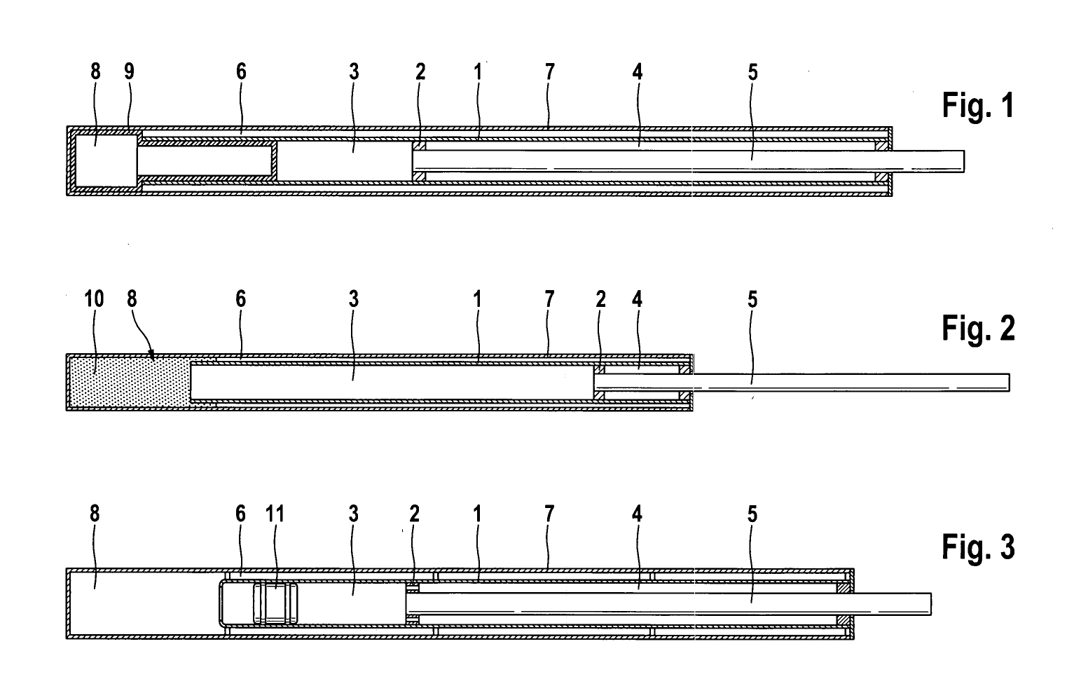

In FIG. 1, the cylinder 1 is enclosed a short distance away by a compensating cylinder 7, which is closed at both ends. The annular space formed between the cylinder 1 and the compensating cylinder 7 is the compensating space 6, which is filled with the compensating medium. The compensating medium can be, for example, water.

The compensating cylinder 7 extends beyond the cylinder 1 on the side opposite the piston rod 5 so that in this end area of the compensating cylinder, a space 8 is formed. Both the cylinder 1, which is open at this end, and the compensating space 6, also open at this end, open out into this space. A fluid-filled elastic bladder 9 is installed in the space 8 and projects into the first working space 3 of the cylinder 1.

When the ambient temperature falls below 0° C., the water in the compensating space 6 freezes to ice, which leads to an increase in the volume of this compensating medium. The ice expands in the axial direction into the space 8, and there it expands radially inward, as a result of which the bladder 9 is compressed. The volume of fluid in the bladder 9 thus displaced is shifted into the cylinder 1 and reduces there the volume of the first working space 3, so that the temperature-caused pressure drop in the cylinder 1 is compensated.

The exemplary embodiment of FIG. 2 is largely the same as that of FIG. 1.

Instead of a fluid-filled bladder, however, a sponge 10 is provided in the space 8. The pores of the sponge are filled with water. When the temperature falls below 0° C., the sponge is displaced into the cylinder 1 in the same way as explained on the basis of FIG. 1.

The exemplary embodiment of FIG. 3 is also largely the same as that of the exemplary embodiment according to FIG. 1. A separating piston 11, however, is installed in the cylinder 1 with freedom to slide back and forth. The separating piston 11 separates the first working space 3 from the space 8, so that the compensating medium, here an aqueous emulsion present in the space 8 and in the compensating space 6, cannot mix with the gas in the first working space 3.

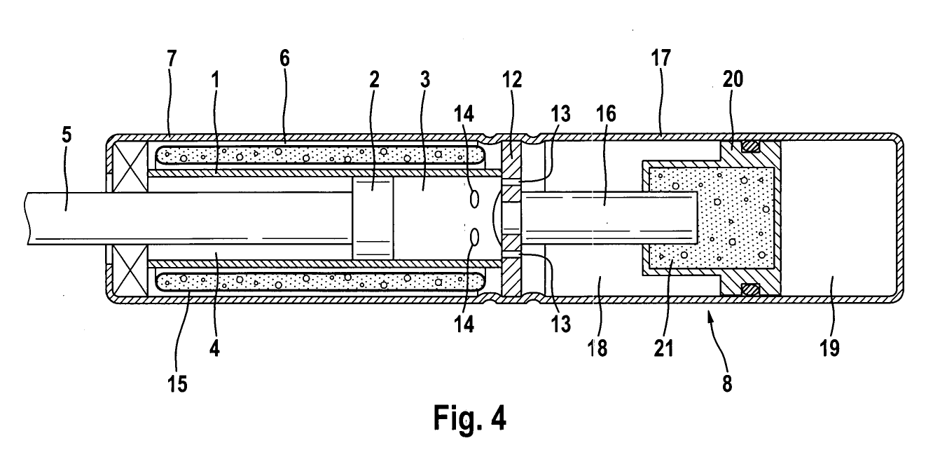

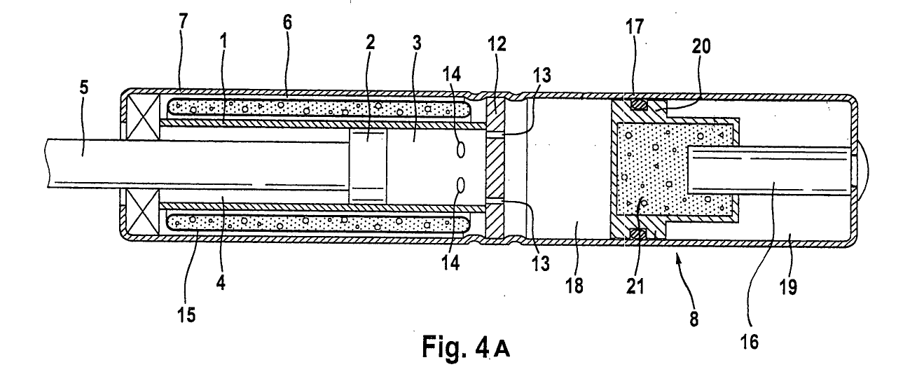

In the case of the exemplary embodiment of FIG. 4, the cylinder 1 is also enclosed by a compensating cylinder 7, which extends beyond the length of the cylinder 1 on the side facing away from the piston rod 5 to form a space 8. The ends of the cylinder 1 and of the compensating space 6 facing the space 8 are closed off by a separating wall 12 in the compensating cylinder 7. Axial connecting openings 13 are provided in the separating wall 12, however, to establish a connection between the first working space 3 and the space 8.

in addition, the first working space 3 is connected to the compensating space 6, which is partially filled with compensating medium, by radial connecting openings 14.

FIG. 4 also shows an elastomeric sleeve 15 filled with water. When the temperature drops below 0° C., the volume of the water-filled sleeve 15 increases and thus reduces the residual volume of the compensating space 6, which is connected to the first working space 3 and thus filled with pressurized gas.

The part of the compensating cylinder 7 projecting beyond the cylinder 1 forms a closed cylinder component 17, the interior of which, i.e., the space 8, is divided by a sliding piston component 20 into a first chamber 18 connected via the axial connecting openings 13 to the working space 3, and a second chamber 19.

One end of a displacement pin 16 is attached coaxially to the separating wall 12, whereas the other end projects through a sealed insertion opening into a compensating chamber 21 inside the piston component 20. The compensating chamber 21 is filled with additional compensating medium. This additional compensating medium, however, expands in volume when the temperature rises and contracts when the temperature falls.

When the temperature rises, therefore, the volume of the additional compensating medium expands and the displacement pin 16 is displaced from the compensating chamber 21, and the piston component 20 is shifted or moved in a direction which increases the size of the first chamber 18. Thus the overall volume of the first working space 3 and the first chamber 18 is increased.

As shown in FIG. 4A, the displacement pin 16 can be installed in the second chamber 18. When the temperature falls below 0° C., the volume of the water-filled sleeve 15 increases or expands, and this increases the pressure in the first working space 3.

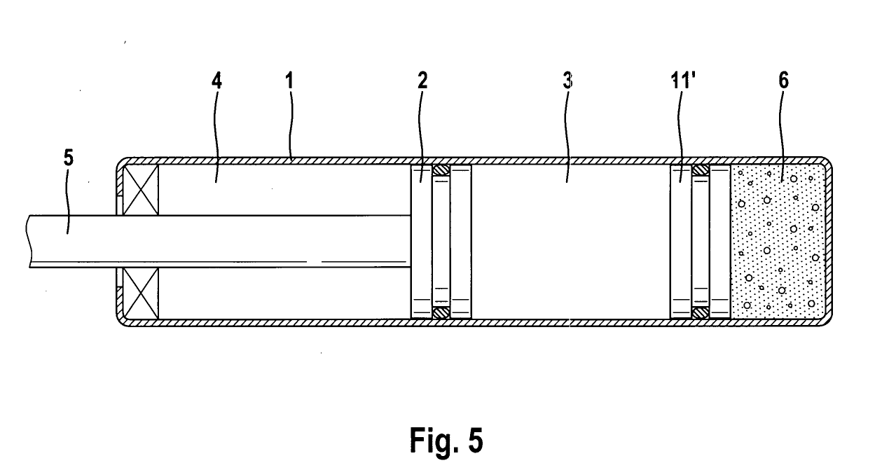

In the exemplary embodiment shown in FIG. 5, the working space 3 in the cylinder 1 on the side of the piston 2 facing away from the piston rod 5 is divided again by a sliding separating piston 11′ so that the gas in the first working space 3 is separated from the compensating space 6, which occupies the terminal area of the cylinder 1 and is filled with a compensating medium.

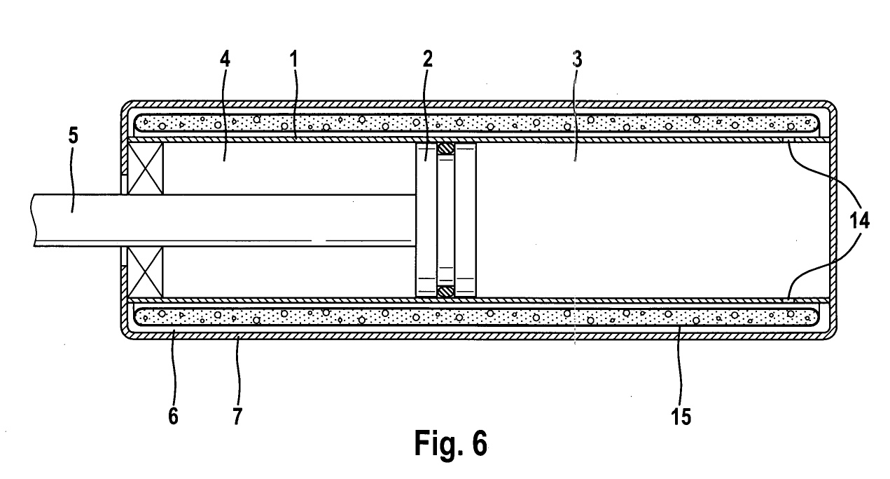

The exemplary embodiment of FIG. 6 has a cylinder 1 surrounded a short distance away by a compensating cylinder 7. The annular space formed between the cylinder 1 and the compensating cylinder 7 is the compensating space 6.

Because the cylinder 1 extends over the entire length of the compensating cylinder 7, radial connecting through-openings 14 are provided at the end of the cylinder 1 facing away from the piston rod 5 to connect the compensating space 6 with the first working space 3. In a manner corresponding to FIG. 4, a water-filled elastic sleeve 15 is provided in the compensating space 6.

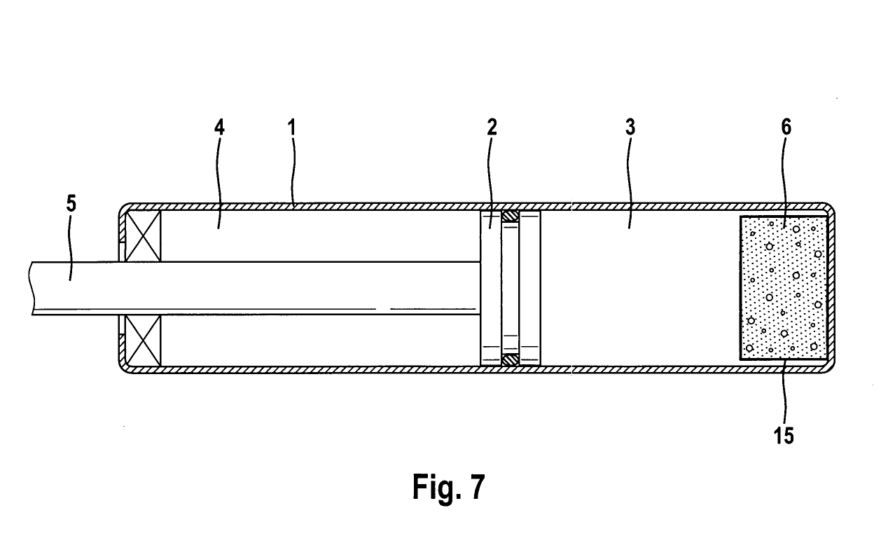

The design of the exemplary embodiment of FIG. 7 is more-or-less the same as that shown in FIG. 5. The separating piston, however, has been omitted, and the compensating medium is provided in a water-filled elastic sleeve 15.

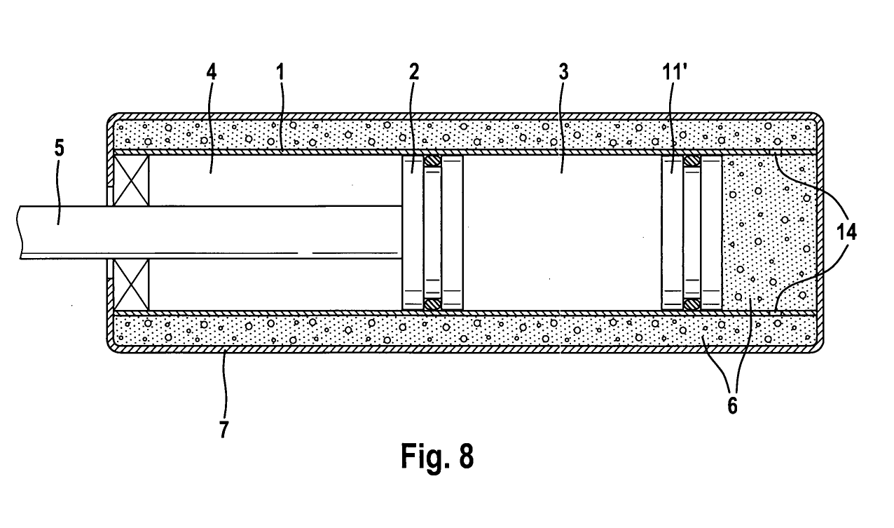

In FIG. 8, the cylinder 1 is the same as the cylinder 1 shown in FIG. 5. In addition, the cylinder 1 is enclosed by a compensating cylinder 7 in the same way as in FIG. 6, where the annular space formed between the cylinder 1 and the compensating cylinder 7 again forms the compensating space 6. This compensating space 6, which is filled directly with the compensating medium, extends through the radial connecting openings 14 into the part of the cylinder 1 separated by the separating piston 11′ from the first working space 3.

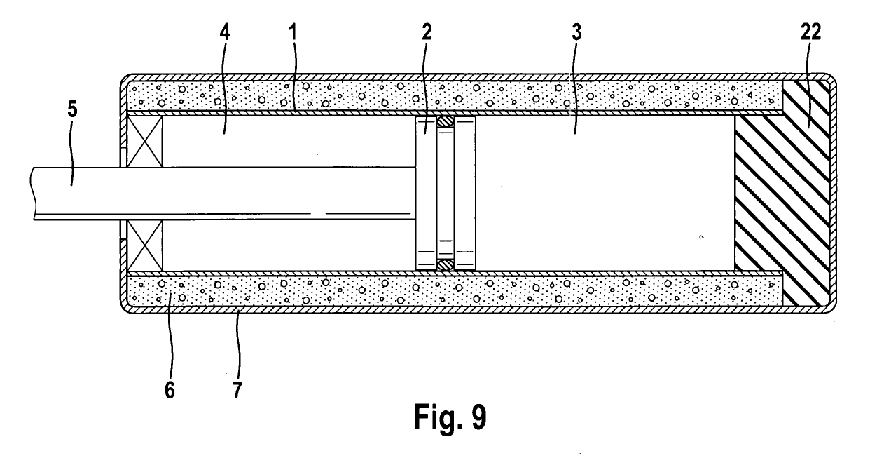

The exemplary embodiment of FIG. 9 is largely the same as that of the exemplary embodiment of FIG. 2, but the sponge has been replaced by an elastomeric component 22.

Thus, while there have shown and described and pointed out fundamental novel features of the invention as applied to preferred embodiments thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A gas spring comprising:
a closed first cylinder;
a piston axially movable in the first cylinder, the piston dividing the first cylinder into a first working space and a second working space, the first working space and the second working space being filled with pressurized gas;
a piston rod on the piston, the piston rod extending through the second working space and sealingly out of the first cylinder; and
a compensating space filled with an incompressible compensating medium which expands in volume as temperature falls, the expansion in volume of the compensating medium causing a decrease in volume of the first working space.

2. The gas spring of claim 1, wherein the compensating medium continuously expands in volume as the temperature continuously falls.

3. The gas spring of claim 1, wherein the expansion in volume of the compensating medium compensates for decrease in pressure of the pressurized gas in the first working space caused by the temperature fall.

4. The gas spring of claim 1, wherein the compensating medium is one of water and an aqueous medium.

5. The gas spring of claim 4, wherein the compensating medium is an aqueous emulsion.

6. The gas spring of claim 1, further comprising a movable wall separating the first working space from the compensating medium.

7. The gas spring of claim 6, wherein the movable wall is a separating piston which is axially movable in the first cylinder and separates the first working space from the compensating space.

8. The gas spring of claim 1, further comprising a flexible sleeve containing the compensating medium.

9. The gas spring of claim 8, wherein the flexible sleeve is an elastomeric sleeve.

10. The gas spring of claim 8, wherein the flexible sleeve is disposed in the first working space.

11. The gas spring of claim 1, wherein the first cylinder is surrounded by a closed second cylinder, the compensating space comprising the annual space between the first and second cylinders.

12. The gas spring of claim 11, wherein the compensating medium is provided in a flexible sleeve disposed in the annular space.

13. The gas spring of claim 6, wherein the movable wall comprises a plastically deformable, incompressible transfer medium.

14. The gas spring of claim 13, wherein the plastically deformable, incompressible transfer medium is a sponge.

15. The gas spring of claim 13, wherein the plastically deformable, incompressible transfer medium is an elastomeric component.

16. The gas spring of claim 13, wherein the plastically deformable, incompressible transfer medium is a fluid-filled bladder, the volume of the fluid remaining substantially constant when temperature changes.

17. The gas spring of claim 1, further comprising:
a closed cylinder component;
a piston component axially movable in the cylinder component, the piston component dividing the cylinder component into a first chamber connected to and communicating with the first working space and a second chamber, the piston component comprising a compensating chamber filled with additional compensating medium which expands in volume as temperature rises; and
an axially oriented displacement pin in the cylinder component with one end being installed in one of the first chamber and the second chamber and the other end sealingly extending into the compensating chamber,
wherein when the displacement pin is installed in the first chamber, the volume of the additional compensating medium expands as the temperature rises, the expansion in volume of the additional compensating medium causing the piston component to move toward the second chamber so that the overall volume of the first working space and the first chamber is increased, and
wherein when the displacement pin is installed in the second chamber, the volume of the compensating medium expands and the volume of the additional compensating medium contracts as the temperature falls, the expansion in volume of the compensating medium and the contraction in volume of the additional compensating medium causing the piston component to move toward the second chamber so that the overall volume of the first working space and the first chamber is increased.
